(19) United States
(12) Patent Application Publication
(10) Pub. No.: US 2018/0081330 A1
(43) Pub. Date: Mar. 22, 2018

(54) Method and Apparatus for Controlling an Environment Management System within a Building

(71) Applicant: Energy Technologies Institute LLP, Loughborough, Leicestershire (GB)

(72) Inventors: Andrew Michael HASLETT, Heswall (GB); John Irwin Michael BATTERBEE, Edgbaston (GB); Darren ROBINSON, Nottingham (GB); Parham A. MIRZAEI, Nottingham (GB); Mazin ALALWANY, Nottingham (GB); Said JABOOB, Dunkirk (GB); Ana Sancho TOMÁS, Nottingham (GB)

(73) Assignee: Energy Technologies Institute LLP, Loughborough, Leicestershire (GB)

(21) Appl. No.: 15/553,390

(22) PCT Filed: Feb. 29, 2016
(86) PCT No.: PCT/GB2016/050519

§ 371 Date: Aug. 24, 2017

(30) Foreign Application Priority Data
Feb. 27, 2015 (GB) 1503302.0

(51) Int. Cl. G05B 13/04; G05B 13/02

(52) U.S. Cl. CPC G05B 13/048; G05B 13/027

(57) ABSTRACT

Method of operating an environment management system within a building uses each of at least a first and a second model to predict, for a chosen time period ahead, one or both of: i) control requirements for the environment management system in light of a current measured system state and a desired future system state or ii) a future system state that would be reached with a particular set of control inputs. The first model is a parameterised physical model of the building and the second model is an implicit model of the building. Prediction models are evaluated, a band of uncertainty determined, and a control strategy that minimizing a likely level of deviation from the desired future system state selected. The control strategy comprises control parameters for the environment management system. The environment management system controls the environment in the building in accordance with the selected control strategy.

### TECHNICAL FIELD

The present invention relates to a method and apparatus for controlling an environment management system within a building.

### BACKGROUND TO THE INVENTION

Buildings are at least as highly individual as people. Although there are classifications of dwellings by archetypes, there are at least a hundred of these. It is also clear that many members of these archetypical groups differ significantly from each other because of differences in construction details, later modifications and different states of repair. Building systems and, in particular, heating and ventilating systems also vary widely and the interaction between these systems and the buildings they are used in is complex.

Furthermore, identical buildings with different occupants can have quite different energy behaviours. Moving an individual into a different group of occupants in a different building also causes significant changes of behaviour. Although it is clear that the behaviour of a boiler is intimately linked to the other components in the heating system as well as the building and the occupants, it may not be so immediately obvious that the energy use of a freezer depends on where it is located in a building and the physics of the micro-environment around the condenser especially.

The application of sophisticated control to buildings and especially domestic buildings has been quite limited to date and especially in respect of incorporating building physics models into the control scheme. With the advent of more affordable and powerful home automation components there is now an opportunity to implement more effective control. Generically, building physics models form part of the set of functions of a Building Environment Management System (BEMS). However, the opportunity for the present invention is most significant in Home Environment Management Systems (HEMS). For the sake of brevity, the remainder of the specification therefore tends to refer to HEMS only. It should, however, be understood that the invention can be applied to any BEMS, not just a HEMS.

The current state of the art includes: a) multi-zonal control of heating systems through a central controller connected to individual room thermostats; b) detection of high heat inputs and low rates of heating signalling open windows and avoiding waste by reducing heating; c) estimation of the time required to heat a zone in order to schedule a target temperature by time rather than a heating on/off control.

While each of the above systems can be superior to timed operation of a heating system with individual zonal thermostats (for example, Thermostatic Radiator Valves TRVs), they fail to address some important requirements relating to building heating and thermal dynamics.

The present invention has therefore been designed with the foregoing in mind.

### SUMMARY OF THE INVENTION

Some examples of factors that current systems fail to adequately address are as follows:
Heat leakage between zones is often significant (e.g. through doors, walls, floors and ceilings). Unless an allowance is made for this, then a target temperature can be hard to achieve, due to coupling between nominally independent control loops in different zones.
Solar gain can be a very significant source of heat, even in winter, and unless this is included explicitly in the control model it can lead to over-heating, wasted energy use and even window opening on cold days. Notably, a conservatory can be a heat source or a heat sink.
The time required to heat a zone is a multi-factorial problem and includes factors such as whether doors are open or closed and the current temperature of the building fabric thermal mass etc. Heat up rates will be slower on cold days than hot ones, for example.
Although detecting an open window through excessive heat input in relation to a rate of temperature increase is a state-estimation method, this will inevitably be just a crude way of throttling excessive heat supply unless a wider range of environmental parameters is taken into account. For example, there is a risk of turning off the heating near to external doors every time they are opened, depending on the location of the heater and thermostat relative to the door.
Human comfort depends on a wider range of factors than air temperature and estimating these factors is an important requirement of an effective HEMS.
In certain circumstances humidity management is important, which also requires modelling, recognition of forced and fugitive ventilation and contributions from cooking, bathing, washing, as well as estimating humidity in different zones and the risks of condensation and damp on walls, windows, fittings and furnishings etc.
Elements of the system can have heating effects as well as delivering a primary benefit, for example towel rails/radiators and showering/bathing.
Control can be improved by the HEMS recognising and estimating the contributions of heating from appliances (including secondary heating) and human activities. This is especially true of well-insulated buildings where the challenge is as much to avoid over heating as to heating the zones.
Given the very wide range of states of the building, human activities within the building and external environmental factors it is hard to predict the outcome of a particular control action.

Generically, the building physics module of a HEMS can also provide inputs to other processes, for example the likely cost impact of changing set-points in different zones or identifying the likely causes of major building fabric inefficiencies.

A potential approach to building physics is to use detailed modelling tools to calculate the building response, based on a very accurate description of the building and its components. This method has been used for a small number of buildings as part of a design-build-verify approach to building physics and efficiency. For large commercial buildings with major environmental control problems this may be a cost-effective way of dealing with loss of rental value and amenity through offline modelling and design modifications. However the level of expertise, sophistication and data required to produce a faithful model of a building in this way is very high and quite beyond what could be achieved for a dwelling. Not only is the cost-benefit ratio unacceptable for dwellings but the model is harder to achieve through less access to as-built data, greater exposure of the zones to external environmental effects and more complex and variable patterns of occupation than a hotel or office block. The applicants therefore propose a solution to this problem.

According to a first aspect of the present invention there is provided a method of operating an environment management system within a building as defined in claim 1. The method comprises: for each of at least a first and a second model:
A. using the model to predict, for a chosen time period ahead, one or both of: i) control requirements for the environment management system in light of a current measured system state and a desired future system state or ii) a future system state that would be reached with a particular set of control inputs; wherein the first model comprises a parameterised physical model of the building and the second model comprises an implicit model of the building;
B. evaluating the predictions of the first and second models based on prior success at predicting the building's thermal behaviour for conditions similar to conditions that are forecast for the chosen time period ahead; and
C. determining a band of uncertainty for the desired or predicted future system state.

Based on the determined uncertainty bands, the method selects a control strategy that minimises a likely level of deviation from the desired future system state, the control strategy comprising control parameters for the environment management system, and operates the environment management system to control the environment in the building in accordance with the selected control strategy.

Embodiments of the first aspect of the invention therefore enable model-based predictive control of a HEMS while minimising the risk of dissatisfaction due to inaccuracies in the modelling. The method provides a way of introducing a cautious approach into the control strategy. By running each of the two types of models and comparing them with historical data from previous time periods and model predictions, a range, or band, of uncertainty as to the likely accuracy of the model predictions can be established. This then allows a “safe” strategy to be determined based on minimising the likelihood of the strategy leading to a condition of the building (system state) that is too far away from the desired condition.

According to a second aspect of the present invention there is defined a method of operating an environment management system within a building as defined in claim 1. The method comprises:
using a first model to predict, for a chosen time period ahead, one or both of: i) control requirements for the environment management system in light of a current measured system state and a desired future system state or ii) a future system state that would be reached with a particular set of control inputs; wherein the first model comprises a parameterised physical model of the building;
using a second model to predict, for the chosen time period ahead, one or both of: i) control requirements for the environment management system in light of the current measured system state and the desired future system state or ii) a future system state that would be reached with a particular set of control inputs; wherein the second model comprises an implicit (black box) model of the building;
evaluating the predictions of the first and second models based on prior success at predicting the building's thermal behaviour for conditions similar to conditions that are forecast for the chosen time period ahead;
selecting one of the first and second models, based on the evaluation; and
operating the environment management system to control the environment in the building in accordance with the selected model for the chosen time period.

Embodiments of the second aspect of the invention enable model-based predictive control of a HEMS with greater reliability than in prior art systems due to the evaluation of two different types of models to determine the one that is most likely to give the best results for a given set of circumstances and to control the HEMS on that basis. It is believed that the hybrid approach of the present invention will enable the control system to account for inevitable errors and unknown variables in the dynamic operation of the building. Embodiments of the invention may comprise predicting values of future environmental variables and possible future control inputs.

Embodiments of both the first and second aspects of the present invention may be performed by a building physics module/unit which forms a part of an environment management system. The building physics module may form an integral part of the system or may be a discrete unit.

The methods may comprise the construction of plausible hypotheses about the building physics (i.e. thermal dynamics) based on inspection by an experienced installation engineer and/or user input. Support tools may be provided to aid the collection of appropriate building data. The data collection may be influenced by data collected from other similar buildings containing environment management systems. For example, the system may determine that for certain types of buildings, certain data is more important than other data. The hypotheses may be used to predict a building response to control and other factors (i.e. weather).

The methods may comprise a setup/installation process that attempts to identify major appliances and their location within the building and to use the social interaction between the installer and building occupants to configure the system to suit their needs. The setup process may also comprise inputting data relating to the structure and properties of the building (for example, including room layout or functional zones, location and properties of windows, doors, radiators etc.). Embodiments of the invention may be designed to maximise the utility of the information collected during system installation and throughout the lifetime operation of the HEMS.

The first model may comprise one or more sub-models selected from a stock of building sub-system models, which may be selected by an installation engineer upon system installation, or may be identified by the system in light of data input by the installation engineer.

The methods may further comprise determining a minimum set of parameters that can provide an effective representation of a building. A relatively long time series of actual data from one or more buildings may be analysed to make this determination.

The methods may further comprise tuning the model parameters until the model explains the measured system state (i.e. represents the building's thermal dynamics). This may comprise modelling dynamics of one or more building systems (e.g. heating, ventilation, hot water systems) and its interaction with the physics of the building (e.g. location of windows).

The methods may comprise a training period to identify appropriate component models and their parameters. The training period may be segregated by characteristic parameters. In other words, the sub-models (equations and parameters) may be classified according to environmental factors that have been shown to discriminate between the utility of models in general in other similar buildings and, specifically, historically in the present building. For example, the segregation may be by when the building is occupied, when the building is occupied but all are asleep, when the building is unoccupied, by external temperature level or time of day relative to sunrise/sunset. It should be understood that any such segregation may be quite coarse, but multi-dimensional.

The segregation may have a dimensionality that is reduced by Principal Component Analysis to identify periods which genuinely produce distinct sets of model and parameter representations. Additional dimensions of model training period segregation may be identified from historic data and/or by adding additional measured and estimated parameters from other buildings as putative dimensions. Analysis of time period characteristic dimensions across multiple environment management systems in buildings of similar use (dwellings, offices, leisure centres etc.) may be used to seed or initiate the segregation process.

The training period may comprise simplifying the first model by grouping some of the terms together (e.g. when the system is identified as being over-parameterised).

The first model may comprise use of Continuous Time Stochastic Models.

The second model may comprise a set of sub-models developed based on segregation by the same environmental factors as referred to above. The identification of sub-models may be developed using actual measured data.

The second model may comprise an Artificial Neural Network. It should be noted that the second model is an implicit (black box) model of the system whereas the first model (which is a parameterised physical model) may be considered as a quasi-explicit (grey box) model of the system.

It should be noted that references to the first and second models do not imply a temporal order to the method but simply denote two different types of model.

The methods may comprise identifying hidden state variables (for example, door and window opening, blind raising and lowering, internal temperature of walls and windows, the temperature of radiators, curtain opening or closing, air exchange (i.e. ventilation) rates) in the first model and/or sub-models and may comprise hypothesising a probable state of said hidden state variables in a predetermined time period. Such hypotheses may be used within control algorithms to deliver comfort parameters such as air temperature, humidity levels and ventilation control.

The sub-models offered for selection by an installation engineer may be chosen or ordered to reflect model structures and/or parameter probability distributions that have been determined to be most successful across multiple (e.g. similar) environment management systems.

The sub-models may be configured to receive inputs from other parts of the environment management system, which may enable estimates to be made of physics inputs such as human metabolic heat input, heat gains from appliances, secondary heating (e.g. from towel rails, showering or bathing), forced ventilation systems, dehumidifiers and humidity sources such as washing, drying and cooking.

The steps of evaluating the predictions of the first and second models may comprise comparing model outputs and/or energy inputs.

The steps of controlling the environment management system may comprise controlling one or more of: a heating system, a hot water system, a ventilation system and a cooling system to achieve the desired future system state.

The system may be controlled to manage one or more of heat, humidity, condensation and mould.

The methods may further comprise using parameters from either or both of the first and second models in functions other than direct control of the environment management system. Such functions may comprise one or more of: budget management, appliance selection, home improvement advice, estimating inherent building efficiencies, providing evidence to support social payments, targeting sales of products and services etc.

In embodiments of the second aspect, if, under certain circumstances (i.e. for a particular segregation), one of the first or second models is determined to generally always be selected, the system may adapt and may always use that model without evaluating the other model.

In embodiments of the invention, a central server may be provided to gather data from a plurality of HEMS. In which case, the central server will be able to build up an extremely valuable database of properties of buildings in different areas. Furthermore, data gathered across a large stock of buildings may enable the construction of a set of models and parameters that will have a high chance of working effectively in a new building in a relatively short time-scale (i.e. out of the box).

In accordance with a third aspect of the invention, there is provided an apparatus for controlling an environment management system within a building, comprising:
apparatus for measuring a current system state; and
a processor configured to:
   use a first model to predict, for a chosen time period ahead, one or both of: i) control requirements for the environment management system in light of the current measured system state and a desired future system state or ii) a future system state that would be reached with a particular set of control inputs; wherein the first model comprises a parameterised physical model of the building;
   use a second model to predict, for the chosen time period ahead, one or both of: i) control requirements for the environment management system in light of the current measured system state and the desired future system state or ii) a future system state that would be reached with a particular set of control inputs; wherein the second model comprises an implicit (black box) model of the building;
   evaluate the predictions of the first and second models based on prior success at predicting the building's thermal behaviour for conditions similar to conditions that are forecast for the chosen time period ahead;
   select one of the first and second models, based on the evaluation; and
   operate the environment management system to control the environment in the building in accordance with the selected model for the chosen time period.

In accordance with a fourth aspect of the invention, there is provided a building environment management system comprising the apparatus according to the second aspect.

The third and fourth aspects of the invention may comprise any of the features described above in relation to the first and second aspects of the invention.

According to a fifth aspect of the present invention there is provided an apparatus for operating an environment management system within a building, comprising: apparatus for measuring a current system state; and a processor configured to, for each of at least a first and a second model:
A. use the model to predict, for a chosen time period ahead, one or both of: i) control requirements for the environment management system in light of the current measured system state and a desired future system state or ii) a future system state that would be reached with a particular set of control inputs; wherein the first model comprises a parameterised physical model of the building;
B. evaluate the predictions of the first and second models based on prior success at predicting the building's thermal behaviour for conditions similar to conditions that are forecast for the chosen time period ahead;
C. determine a band of uncertainty for the desired or predicted future system state.

Based on the determined uncertainty bands, the processor selects a control strategy that minimises a likely level of deviation from the desired future system state, the control strategy comprising control parameters for the environment management system. The processor operates the environment management system to control the environment in the building in accordance with the selected control strategy.

In accordance with a six aspect of the invention, there is provided building environment management system comprising the apparatus according to the fifth aspect.

The fifth and sixth aspects of the invention may comprise any of the features described above in relation to the first and second aspects of the invention.

### BRIEF DESCRIPTION OF THE DRAWINGS

Embodiments of the invention will now be described, by way of example only, with reference to the Figures of the accompanying drawings in which:

FIG. 1 shows a flow chart illustrating the overall formulation of a building physics module in accordance with an embodiment of the present invention (including a training phase and a subsequent application phase);

FIG. 2 shows a flow chart illustrating an initial training period of an artificial neural network (ANN) in accordance with an embodiment of the invention;

FIG. 3 shows a flow chart illustrating continued operation of the ANN of FIG. 2;

FIG. 4 shows a flow chart illustrating a Forward Selection Process in accordance with an embodiment of the present invention;

FIG. 5 shows a flow chart illustrating an initial training period of a Continuous Time Stochastic Models (CTSM) in accordance with an embodiment of the invention;

FIG. 6 shows a flow chart illustrating model selection in accordance with an embodiment of the present invention; and

FIG. 7 shows a flow chart illustrating the application of the ANN of FIGS. 2 and 3 in accordance with an embodiment of the invention.

### DETAILED DESCRIPTION OF EMBODIMENTS OF THE INVENTION

An embodiment of the present invention will now be described in the context of a building physics module (BPM) within a Home Environment Management System (HEMS), as a specific case of a Building Environment Management System (BEMS).

The purpose of this particular BPM/system is to predict, in real time, the temperature and heating demands of each room in a home. More precisely, the home will be split into thermal zones, each with their own sensors. The module will resolve the data for temperatures and recommended heating demands in each zone and will provide control signals to action the recommended heating levels.

In principle, the models described can be used to estimate the heat inputs required to reach a future desired state or the future state that would be reached with a particular set of heat inputs. In some embodiments, both functions may be required for effective control optimisation. Thus, the BPM of some embodiments constitutes an apparatus for operating an environment management system within a building and comprises: apparatus for measuring a current system state; and a processor configured to: use a first model to predict, for a chosen time period ahead, one or both of: i) control requirements for the environment management system in light of the current measured system state and a desired future system state or ii) a future system state that would be reached with a particular set of control inputs; wherein the first model comprises a parameterised physical model of the building; use a second model to predict, for the chosen time period ahead, one or both of: i) control requirements for the environment management system in light of the current measured system state and the desired future system state or ii) a future system state that would be reached with a particular set of control inputs; wherein the second model comprises an implicit (black box) model of the building; evaluate the predictions of the first and second models based on prior success at predicting the building's thermal behaviour for conditions similar to conditions that are forecast for the chosen time period ahead; select one of the first and second models, based on the evaluation; and operate the environment management system to control the environment in the building in accordance with the selected model for the chosen time period.

The BPM of some embodiments constitutes an apparatus for operating an environment management system within a building, comprising: apparatus for measuring a current system state; and a processor configured to, for each of at least a first and a second model: A. use the model to predict, for a chosen time period ahead, one or both of: i) control requirements for the environment management system in light of the current measured system state and a desired future system state or ii) a future system state that would be reached with a particular set of control inputs; wherein the first model comprises a parameterised physical model of the building; B. evaluate the predictions of the first and second models based on prior success at predicting the building's thermal behaviour for conditions similar to conditions that are forecast for the chosen time period ahead; and C. determine a band of uncertainty for the desired or predicted future system state. Based on the determined uncertainty bands, the processor selects a control strategy that minimises a likely level of deviation from the desired future system state, the control strategy comprising control parameters for the environment management system. The processor operates the environment management system to control the environment in the building in accordance with the selected control strategy.

Installation and Setup

The thermal zones will be defined during installation of the system by the installation engineer, who will assign a zone to each individually heated space. Each space may be thermally-coupled to one or more other heated spaces, in which case these connections should also be input to the system by the engineer, so that the BPM can resolve the associated heat exchanges. The engineer will be provided with tools that enable a spatial model of the building and its contents and appliances to be constructed, which will support a number of HEMS functions, including the BPM.

The BPM may require the engineer to assign and dimension components such as doors, windows, radiators etc. and to identify features such as blinds, curtains canopies, as well as sub-systems such as the heating and water system, extractor fans and hoods and any other features that could contribute to the generation and transfer of heat and moisture within, into and out of the building, including storage reservoirs, such as the thermal capacity of walls and radiators or the location of soft furnishings, towels etc.

System Overview

The present embodiment illustrates how the invention can be implemented in respect of heating control in a building using Continuous Time Stochastic Models and Artificial Neural Networks. It should be clear to one skilled in the art where Bayesian Statistics, Principal Component Analysis and analytical techniques for similarity and congruence in multi-dimensional space (for example Euclidian separation and morphological categorisation) can be applied. How these concepts could be extended to include humidity or extract hidden state estimations (i.e. a door has been closed) from the models is not explicitly discussed but will be clear from the overall teaching of this specification and the particular exemplification that follows.

Two different types of model are utilised in the present BPM: the first model comprises Artificial Neural Networks (ANN) and the second model comprises Continuous Time Stochastic Models (CTSM). In some embodiments the system uses predictions of both models and evaluates the predictions based on prior success at predicting the building's thermal behaviour for conditions similar to conditions that are forecast. The system then determines a band of uncertainty for the desired or predicted future system state and selects a control strategy that minimises a likely level of deviation from the desired future thermal state of the building. In other embodiments the system selects the most appropriate model to use for each 24 hour period, based on its prior success at predicting the buildings' thermal behaviour for conditions similar to those which are forecast for the day ahead.

ANN is a ‘black box’ model, such that its internal processes have no physical meaning. This can be an advantage as it can model phenomena that are unknown or that cannot be defined physically, as long as there is a proxy input for the description of such phenomena.

CTSM, on the other hand, is more flexible as it has physical meaning. This ‘grey box’ model also requires considerably less data to produce reliable results and can explicitly model changes in the envelope of the building (i.e. due to a window being opened), including hidden state variables.

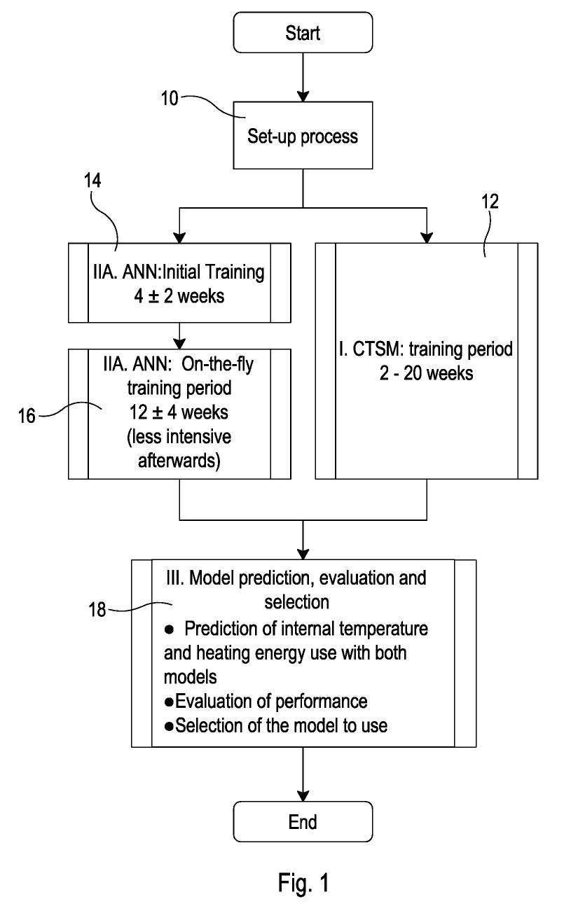

FIG. 1 illustrates how the two approaches may be used together in the BPM. After an initial set-up process 10, as described above, the system will begin with training periods for both models. During this time neither approach is likely to provide reliable results (as both models require to be calibrated to the behaviour of the specific building being controlled). However, in the first instance a default CTSM model could be utilised for approximate control actions until it can be replaced by a model trained to the actual building. The HEMS may also be learning about other characteristics of the building during this time, for example, patterns of occupation. The functionality of the HEMS will therefore be less initially and a precautionary approach will be taken to control actions to avoid unfortunate outcomes based on inappropriate assumptions. Effectively the HEMS will behave like a digital version of a multi-zone conventional heating system, but with a little more accuracy.

The first model (CTSM) may require a training period (Process I) step 12 that requires a cumulative period of around three heating season days, during which time the building is unoccupied and the exterior envelope is sealed (e.g. windows and external doors are closed). This may require an elapsed time of as much as, say, two weeks. This may be sufficient to define a model that describes the thermal performance of the building, with all significant terms of thermal resistance, capacitance and heat gain characterised, in the case of a sealed envelope. A further period of up to eighteen weeks may be required to define a cumulative period of a further three days where, for each zone, the envelope is not sealed (i.e. a door or window is open). Under these conditions modified resistance terms can be estimated, to account for the reduced thermal resistance due to heat transfer through open windows/doors.

With the two CTSM models calibrated (envelope sealed and envelope open) it is straightforward to determine occasions during which a transition from the ‘sealed’ model to the ‘open’ model—and vice versa—is required using the accumulated historical data (e.g. obtained over the training period). This and subsequent data can be used to fit a model to predict the associated transition probabilities, using a binomial family of generalised linear models, as will be described in more detail below. This model can later be used in conjunction with weather forecast and/or occupancy forecast data from other modules to stochastically predict whether windows will be open or closed and thus to select the appropriate CTSM model for each forecast.

The second ‘black box’ ANN model requires no such separation—it implicitly handles both ‘sealed’ and ‘open’ envelope cases. In this case, the model may require an initial training period of at least two weeks' (up to six weeks′) continuous data as per step 14 (Process IIA) in which to configure an approximate model, and with which initial predictions may be made. However, a further eight to sixteen week period of ‘on-the-fly’ continuous training may be required as per step 16 (Process IIB), during which the network is continually updated.

After the training periods described above are complete, a normal run-time (Process III) step 18 comprises model prediction, evaluation and selection. Model prediction may output temperature and heating demand predictions for both model types, the evaluation stage tests these against observed data and the selection process determines which of the ANN and CTSM models is best suited for each forecast day.

The following sections describe in detail the processes involved in each stage of the flowchart in FIG. 1 for both approaches.

ANN Description

Artificial Neural Networks (ANNs) are a type of machine learning algorithm inspired by the functioning of the brain and biological neural networks. They are statistical learning algorithms that allow the construction of mathematical models based on historical observed data, finding relationships between large numbers of parameters. They are thus, classified as black-box models, where the behaviour of certain properties or variables of a system may be estimated depending on a given stimulus, without describing the physical or mathematical processes taking place.

A neural network is a system where nodes, called neurons, are interconnected and distributed in layers in such a way that, from a specific configuration of inputs, an output response can be obtained. The way in which this response is calculated depends on the mathematical activation function used in order to compute the output from the inputs.

The architecture of the network can be defined by the number and types of layers. Commonly, these are one input layer, one or more hidden layers and one output layer.

The performance of ANNs relies on the quantity and quality of the data used to train the network. An appropriate training period is crucial to ensure that the network is reliably configured with a view to reliably forecasting future system behaviour: in this case room air temperature and heating demands.

The network configuration described below has been found successful in balancing accuracy and complexity. It is a Feed Forward Network with three layers: input, hidden and output. However, other types of network, or, indeed, other types of implicit (e.g. time-series) model may be employed in other embodiments.

The input and output layers in the present embodiment are linear layers, whereas the hidden layer follows a sigmoid function (another common possibility is a hyperbolic tangent function). A bias neuron is included in both the input and output layer; this is an extra weighting parameter that improves the learning process of the network by allowing modifications to the activation function as necessary.

In the present case, the input layer comprises the following neurons, for time step t:
time of day
outside temperature
wind speed
incident direct solar irradiation
heat flux from heaters for N thermal zones
internal temperature for N thermal zones
internal temperature differences for each pair of thermal zones (leading to N!/2(N−2)! inputs)

The output layer comprises:
heat flux from heaters for N thermal zones for next time step
internal temperature for N thermal zones for next time step

The hidden layer contains 1.5 times the number of input neurons. For example, in the case of N=4 thermal zones, the input layer will have 18 neurons, the hidden layer will have 27 hidden neurons and the output layer will have 8 neurons (describing the temperature and heat flux outputs for each of the four zones).

Through the weighting parameters that are given to the connections between their neurons ANNs are implicitly capable of describing behavioural influences such as the opening of windows and their impacts on thermal performance and the use of appliances such as gas rings. In fact, the applicants have found that explicit representation of such effects, requiring Boolean variables, tends to destabilise ANNs.

Measurements internal to the building are derived from measurement sensors. A horizontal irradiance sensor may be required to be installed on the roof of the building in which the HEMS is installed, so that local reflecting occlusions to sky and sun are directly represented. Such a sensor should be capable of calculating a split between global (I_{gh}) and diffuse horizontal irradiance (I_{dh}). Given a calculated solar altitude (γ) for the relevant time and location, the beam normal irradiance (I_{bn}) is then simply: I_{bn}=(I_{gh}−I_{dh})/sin γ and the incident direct solar irradiance I(t) [W·m⁻²] is: I_{bn} cos θ, where θ is the angle of incident on the receiving plane (i.e. the window).

It should also be noted that an ANN could be trained to predict local direct horizontal irradiance given the coincident horizontal irradiance measured at a local meteorological station, so that weather forecasts for that station could be localised (indeed this principle could also be applied to other meteorological parameters), for example, the average wind speed and direction. These parameters are also likely to be required for aspects of the second CTSM model described below.

For the purposes of this embodiment, we have assumed that irradiance will need to be measured on each dwelling, whereas wind speed and direction can be estimated from external inputs. Clearly, there is an opportunity to use data across multiple HEMS to improve local estimates of meteorological data and forecasts in combination with other weather data and forecasting.

ANN: Initial Training

ANNs generally need a large amount of data before they start making sensible predictions. For that reason, an initial period of around two weeks is likely to be required to collect data and train the initial network, which will then be subsequently refined and used in the present method.

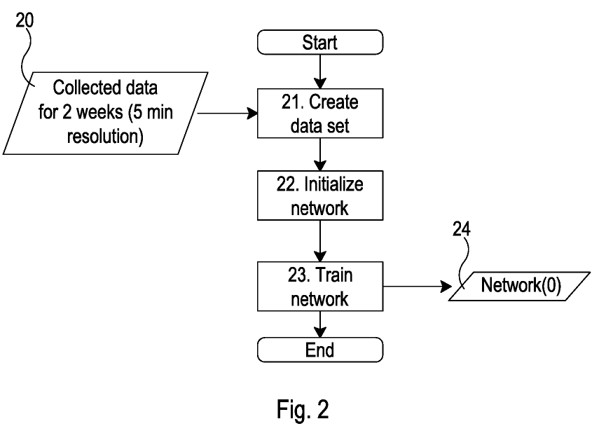

The initial training period for the ANN is described in FIG. 2 and comprises the following steps:

Step 20. Collect data for 2 weeks (e.g. using a data sampling rate of 5 minutes)

Step 21. Create a data set using the data gathered from two weeks of operation. The data set may comprise the following inputs and outputs:
Inputs:
   Time of the day: time
   Outside temperature: Tout(t)
   Wind speed: Sw(t)
   Incident direct solar irradiance: I(t)
   Heat flux from heaters in each zone: Qh_zone(t)
   Zone temperature in each zone: T_zone(t)
   Temperature difference for each pair of zones (i, j): Tdiff_ij(t)
Outputs:
   Heat flux from heaters in each zone for the next time step: Qh_zone(t+1)
   Zone temperature in each zone for the next time step: T_zone(t+1)

Step 22. Initialize neural network (configured with layers and neurons as described above).

Step 23. Train network during at least 100 epochs (i.e. for t=1 to 100).

Step 24. This results in an initial network(0).

ANN: ‘On-The-Fly’ Continuous Training

After the first two weeks of data is collected and used to train and obtain network(0), a process of dynamic training is implemented. For each 15-minute time step during the next ten weeks, new data is measured and used to retrain the network. The updated network is accepted only when it leads to improved prediction capabilities when compared to network(0).

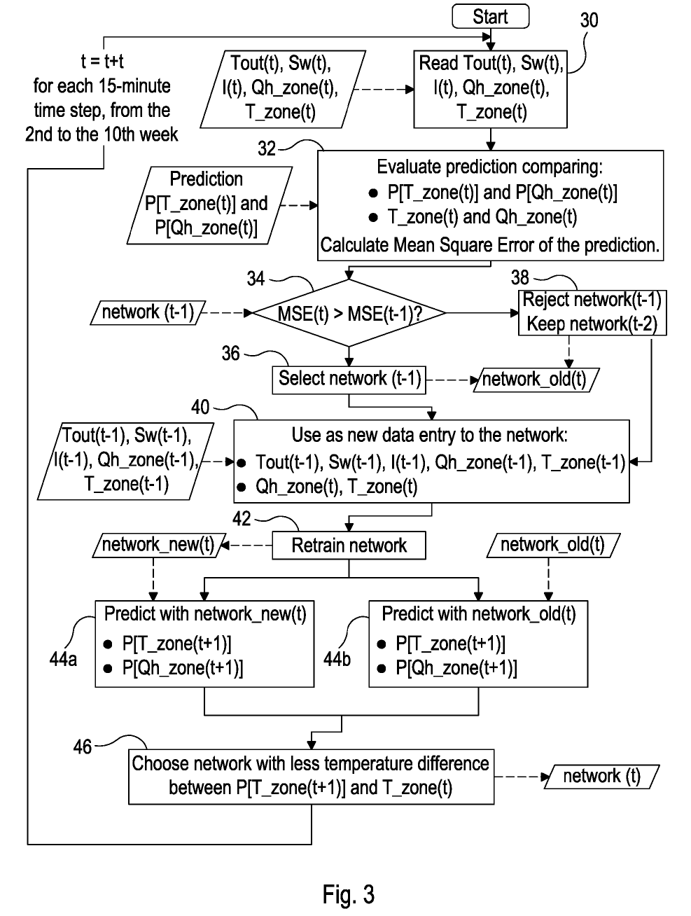

For each time step, the training process is as described in FIG. 3, where dashed lines represent data flows and solid lines represent process links. The steps are as follows:

Step 30. At time t, new measured data is recorded, and can be used to evaluate the predictions made at the last time step. The first step is therefore to read the measured values at t for:
Outside temperature: Tout(t)
Wind speed: Sw(t)
Direct solar irradiation: I(t)
Heat flux from heaters in each zone: Qh_zone(t)
Zone temperature in each zone: T_zone(t)

Step 32. Using both the current measurements of zone conditions (T_zone(t) and Qh_zone(t)) and the prediction of current zone conditions that was calculated at the previous time step P[T_zone(t)] and P[Qh_zone(t)], evaluate the quality of each prediction by calculating the Mean Squared Error, MSE(t), for all zones.

Step 34. Evaluate the performance of the last network used network(t−1) in comparison with the previous network(t−2), by calculating the MSE(t) of the predictions. If the MSE(t) is less than or equal to that calculated for the previous timestep MSE(t−1), network(t−1) is retained (step 36), else network(t−1) is rejected in favour of network(t−2) (step 38). The chosen network is re-named network_old(t).

Step 40. At this point Qh_zone(t), T_zone(t) are measured and known. These values are incorporated into the network_old(t) as target output values. Input values will be the measured values at time t−1. These values therefore constitute an input-output pair that the network can use to retrain:
Inputs: T_out(t−1), Sw(t−1), 1(t−1), Qh_zone(t−1), T_zone(t−1)
Outputs: Qh_zone(t), T_zone(t)

Step 42. The network is retrained with the above data and saved as network_new(t). Step 44a. The next predicted output values for zone temperature P[T_zone(t+1)] and heating P[Qh_zone(t+1)] are forecast using Network_new(t)

Step 44b. The next predicted output values for zone temperature P[T_zone(t+1)] and heating P[Qh_zone(t+1)] are also forecast using Network_old(t)

Step 46. The previous two steps produce two sets of predictions, one for each network (old and new). In order to choose one, the network that predicts the lowest temperature difference (between the prediction and the current temperature) or its MSE will be selected and saved as network(t). This stage avoids predicting large temperature changes in the zones.

The process of FIG. 3 is then repeated for t=t+1 for each 15 minute time step from the second to the 10^{th} week to train the ANN.

CTSM Description

Continuous time stochastic modelling (CTSM) is a process used to solve Stochastic Differential Equations (SDEs). In contrast with traditional Ordinary or Partial Differential Equations (ODEs or PDEs), SDEs can explicitly represent processes that are stochastic in nature. In other words they express randomness due, for example, to thermophysical properties that vary with moisture content, to infiltration that varies with local pressure fluctuations etc. and other processes that affect the dynamic behaviour of a building. Stochastic terms within SDEs are generally random white noise or a derivative of Brownian motion. A Wiener process is the continuous time stochastic process used in an SDE to represent Brownian motion.

CTSM has thus far been used to model the dynamic thermal behaviour of simple mono-zone unoccupied buildings. Embodiments of the present invention extend far beyond the current literature in its aim of modelling a multi-zone home, explicitly accounting for thermal interactions between these zones, and also accounting for occupants' interactions with the home (in particular, with respect to internal heat gains and interactions with envelope openings such as doors and windows). The model can also be adapted to account for seasonal factors and, for example, for variations in the effective solar aperture of windows as nearby obstructions occlude views to the sun during periods of low solar altitude.

CTSM involves estimating the parameters of and then solving a system of stochastic differential equations for each zone (room) within the home. Such systems of equations will be largely similar in structure; their differences will lie in the parameter values that reflect variations in the size and configuration of rooms, the degree of solar exposure, the magnitude of internal heat gains etc. While the systems are inextricably linked they are solved independently, as interactions affecting a zone are resolved for within the system of equations for that zone.

Within each system of equations there are as many equations as there are state variables. These are the key variables that must be predicted in order to model some effect (not all modelled phenomena require state variables). The first and most important state variable is Tᵢ, the internal temperature of the zone. Other equations generally lead on from this and describe the relation between Tᵢ and themselves. Equation [1] below illustrates a basic form of Tᵢ with respect to time t:

$${dT}_{i} = \frac{1}{{R}_{ie} {C}_{i}} ( {T}_{e} - {T}_{i} ) dt + \frac{1}{{C}_{i}} {ϕ}_{h} dt + \frac{1}{{C}_{i}} {A}_{n} {ϕ}_{s} dt + {σ}_{i} d ω \qquad Eq . [ 1 ]$$

in which:
Tᵢ is the internal temperature of the zone
Tₑ is the temperature of the envelope
Cᵢ is the capacitance of the zone—this makes heat transfer realistic and not instantaneous
Rᵢₑ is the resistance between the interior of the zone and the envelope
φₕ is flux from heaters in the room
Aₙ is a constant to adjust incident solar radiation—it is an effective solar aperture
φₛ is the incident solar irradiance
σᵢ is the Wiener process (the derivative of Brownian motion ω)

Equation [1] can be extended to represent other phenomena, for example, to handle interactions with adjacent zones by adding the following additional term:

$$\frac{1}{{R}_{int} {C}_{i}} ( Δ T ) dt$$

where:
Rᵢₙₜ is the inter-zonal transfer resistance (i.e. the resistance offered by internal walls and doors)
ΔT is the difference in temperature between these zones. Owing to the typically small temperature differences between zones, previous time-step data may be used.

In the present case, a new state variable for the temperature in the adjacent zone may be required.

Other internal gains may also be added, but without the need for a further state variable, as this simply requires that an additional term of the form below to be included within the equation for Tᵢ:

$$\frac{1}{{C}_{i}} {ϕ}_{p} dt$$

where φₚ is the incidental internal heat gain within the zone.

A more realistic form of Tᵢ based on the above additions is then as per Equation [2] below:

$${dT}_{i} = ( \frac{1}{{R}_{ie} {C}_{i}} ( {T}_{e} - {T}_{i} ) + \frac{1}{{C}_{i}} ( {T}_{h} - {T}_{i} ) + \frac{1}{{C}_{i}} {A}_{n} {ϕ}_{s} + {\sum }_{n = 1}^{N} \frac{1}{{C}_{i} {R}_{n}} Δ {T}_{n} + \frac{1}{{C}_{i}} {ϕ}_{p} ) dT + {σ}_{i} d ω \qquad Eq . [ 2 ]$$

The summation term represents all adjacent zones (i.e. with N adjacent zones there are N terms for thermal exchange between these and the target zone). Rₙ is the equivalent of the Rᵢₙₜ above. In this example the state variables are:
Tᵢ: Internal temperature
Tₑ: Envelope temperature (representative of the external walls of the building)
Tₙ: Internal temperatures of adjacent zones
Tₕ: Heater temperature

The thermal gain term φₕ is in the state variable equation for Tₕ in this case to allow Tₕ to have a resistance and its own capacitance.

This formulation represents the most demanding case of four state variables depending on adjacent zones. Additional state variables can be added, but these have been found to bring diminishing returns in terms of predictive power, to reduce the likelihood of convergence in the estimation of parameter values and to increase run time.

CTSM-r is a module selected from a statistical computing package R that has been used to estimate the parameters of the above SDEs. There are three model structures to choose from in CTSM-r: linear time-invariant, linear time-variant and non-linear. The equations shown above are linear time-invariant. Given a choice of model structure CTSM-r has three parameter estimation techniques: maximum likelihood, maximum a posteriori and using multiple independent datasets.

Maximum likelihood estimation (ML) estimates parameters that will maximise the likelihood function of a sequence of measurements. The likelihood function L is the joint probability density p as per Equation [3] below:

L(θ;Y_{N})=p(Y_{N}|θ) Eq. [3]

where θ are the parameters and Y_{N} is the sequence of measurements (i.e. the training data for the model). This process selects the parameters most likely to output predictions matching the measured values (training data).

Maximum a posteriori estimation (MAP) is similar to ML but can take advantage of prior information about the parameters. The new probability density function p, in this case, is as per Equation [4] below:

$$p ( θ \vert {Y}_{N} ) = \frac{p ( {Y}_{N} \vert θ ) p ( θ )}{p ( {Y}_{N} )} ∝ p ( {Y}_{N} \vert θ ) p ( θ ) \qquad Eq . [ 4 ]$$

It should be noted that with no prior information MAP reduces to the ML estimation, so that ML is a special case of the MAP estimation. Further, multiple independent data sets is a generalisation of MAP estimation, where the expression for the probability density function in MAP is expanded for multiple consecutive measurements. In the present embodiment MAP estimation is employed but in other embodiments other techniques may be used.

CTSM Modelling

As with ANN, CTSM involves both training and modelling processes. In this particular case, we will consider three distinct training processes of the CTSM model. The first two relate to the estimation of parameters describing the envelope (and within this stage we can select the most efficient form of CTSM model), whilst the latter models occupants' interactions with the envelope, which determines which of the former models should be selected at a given time step.

A period of equivalent continuous data relating to the envelope being either sealed or open is required for training. Notably, this period does not have to be actually continuous; it can consist of separate periods of data spliced together. A usable dataset may be obtained from between around 3 days to a week and the CTSM will estimate the following parameters in the state equation (e.g. Equation [2]):
Resistances, Rᵢₑ Rₙ etc.
Capacitances, Cᵢ Cₑ Cₕ etc.
Stochastic noise variables, (σᵢ dω term)

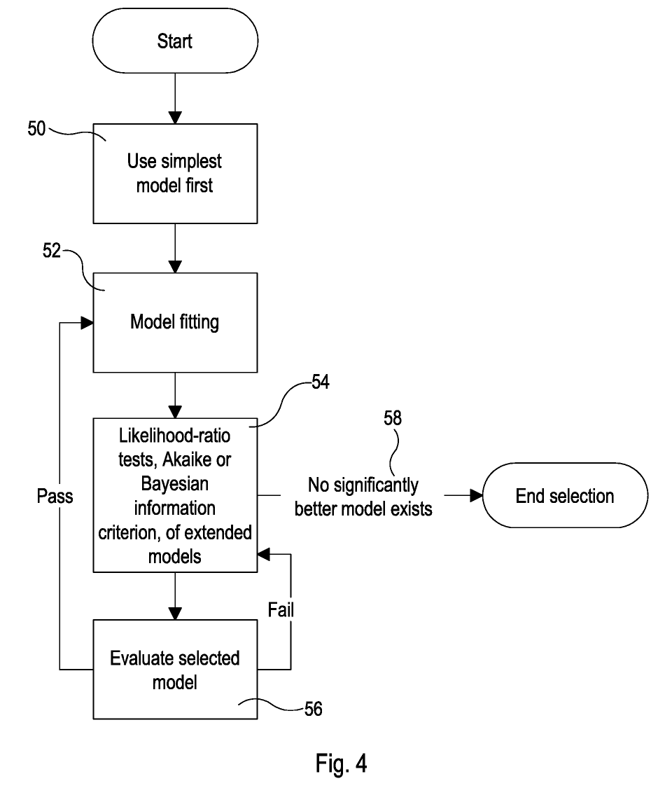

Next, the desired state variable (Tᵢ) is calculated using the predicted parameters through a forward selection procedure, where models are fitted using a maximum a posteriori estimation of the parameters. This process is illustrated in FIG. 4 where the simplest feasible model is used to begin with (step 50), the model is fitted using the estimated parameters (step 52) and then the model is extended by association with the highest log-likelihood (LR) or the lowest Akaike or Bayesian Information criterion (AIC, BIC) (step 54), as long as these extended models bring significant improvements in predictive power; in other words the most parsimonious model is selected.

Selection indicators are used to evaluate and compare the current model versus each of the extended models (step 56) and the possible candidate models for improvement that are selected in each iteration are the smallest extensions to the current model. The procedure stops when no extensions to the model yield a p-value of less than 5% or when the quotient of the change in AIC becomes insignificant (step 58). The p-value is an estimate of the probability that the prediction could have arisen by chance if a null hypothesis were true—i.e. that observations and predictions could be from the same dataset. If the p-value is below the stated significance level (i.e. p<5%) the null hypothesis can be rejected since the two datasets are significantly different from one another. The second criterion exists to ensure that a more complex model is not selected if it insignificantly improves results. The threshold and criteria can of course be adjusted at the modeller's discretion. The selected extended model is evaluated (step 56) and if the result is satisfactory the model is kept and the next iteration can be started, otherwise the previous step 54 is used again to select another extension. During this process each model should also be assessed for the quality of the predictions, for example, based on the following:
The p-value of the t-test is below 0.05 for all parameters. As mentioned above, the p(>|t|) value is the probability that a particular initial state or parameter is insignificant, i.e. equal to 0. If this value is not low (i.e. it should be below 0.05) this can be an indication that the model is over-parameterised.
The derivative of the objective function with respect to each parameter (i.e. dF/dPar) is close to zero, where the objective function is a measure of performance that we want to maximise or minimise.
The derivative of the penalty function with respect to each parameter (i.e. dPen/dPar) is not significant compared to dF/dPar. The penalty function is applied to the objective function to mimic constraints to the objective function (by causing the finite difference derivative to increase when these constraints are being approached).
The Correlation Matrix does not have any off-diagonal values close to −1 or 1. This will provide an indication that the model is over-parameterised and some of the parameters may need to be eliminated.

Once the form of model has been selected in accordance with FIG. 4 for the case where the envelope is closed, the process of parameter estimation should be repeated for the case of the envelope ‘open’. This updates some parameters; in particular, resistances taking into account the operation of doors and windows.

Tᵢ may now be calculated for an occupied building following the above procedure.

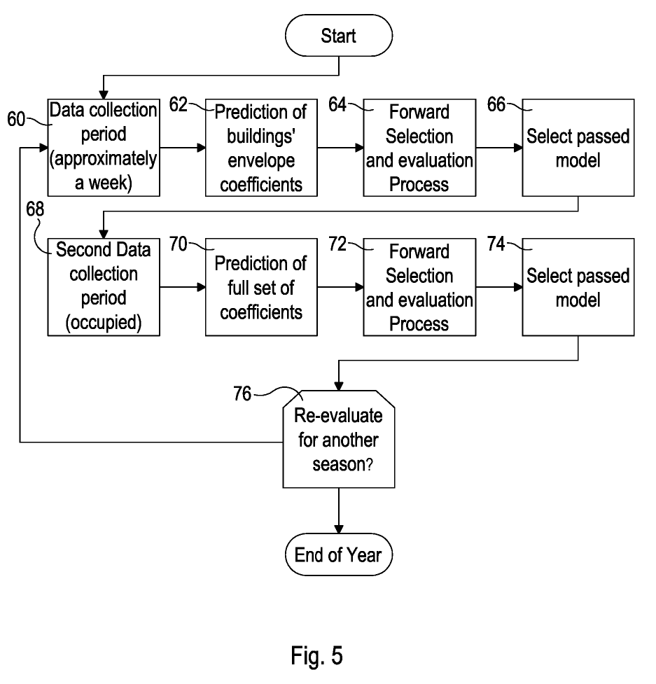

FIG. 5 describes the CTSM training process. In step 60 data is collected over approximately one week. Step 62 then predicts the buildings' envelope coefficients before a forward selection and evaluation process (step 64). The model that best fits the data is then selected (step 66) before a second data collection period in which the building is occupied (step 68). Step 70 then predicts a full set of coefficients before a further Forward Selection and evaluation process (step 72). Again, the model that best fits the data is selected (step 74). Note that in practice there is iteration between steps 63 and 64 and between steps 70 and 72, as new coefficients are estimated for progressively more sophisticated models. The system may then re-evaluate the models for another season (or indeed any other of the multi-dimensional parameters influencing system behaviour) by repeating the above process (step 76) until data has been collected and used to the train the models over an entire year.

As noted earlier, with the two CTSM models (envelope sealed and envelope open) calibrated after the training period it is straightforward to determine occasions during which a transition from the ‘sealed’ model to the ‘open’ model—and vice versa—is required using the accumulated historical data; based on the model that returns the smallest predictive error. This and subsequent data can be used to fit a model to predict the associated transition probabilities, using the binomial family of generalised linear models. This model can later be used in conjunction with weather forecast data to stochastically predict whether windows will be open or closed and thus to select the appropriate CTSM model for these forecasts.

Thus, once we have the following three parameterised models:
CTSM model for the sealed envelope
CTSM model for the open envelope
Model to predict envelope opening probability, using Tᵢ for the previous time step.

We can use the three models during operation of the system (if CTSM is selected for the present day's control) as follows:
Draw a random number. If the probability of a window transitioning to or remaining open exceeds this number then select the envelope ‘open’ model; else, select the envelope ‘closed’ model.
Proceed to predict internal temperature and heat flux for the current time step using the selected model.

Reverse Process (Heating Prediction)

As already noted, it may be important to be able to predict the heating load required to maintain a given target temperature. This can be achieved through a further hybrid model (based on CTSM plus regression). Following results from CTSM for the predicted indoor temperature (as described above), regression analysis can be used to predict heating loads based on the predicted temperature and relevant predictors (e.g. internal temperatures, solar heat gains and internal heat gains).

Regression analysis relates a dependent variable to one or more independent variables. In this case, the dependent variable is φₕ whereas candidate independent variables include:
Tᵢ: Internal temperature, to determine the difference between current and desired temperatures.
φₛ, φₚ: Solar gains and incidental heat gains, as they will offset the heat flux required.

Model Prediction, Evaluation and Selection

The BPM described herein can therefore predict temperatures and heating demands using the two approaches detailed above (ANN and CTSM). In some embodiments, for a given day (say from midnight to midnight) the most appropriate model can be selected, on the basis of past success for the upcoming typology of day, based on weather forecasts for the day. This process will improve over time as the amount of historic performance data increases and the method progressively refines the classification of the models for each typology of day: CTSM or an ANN model.

The typology of the day may take the form of an n-dimensional matrix of occupational and climatic parameters, with the following candidate dimensions:
Occupational: weekday, weekend, vacation.
Climatic, radiative: low, medium and high clearness (bins of clearness index representing low, medium and high radiative transfers, influencing solar utilisation and comfort).
Climatic, thermal: cold, mild and warm (bins of temperature representing likelihood of continuous, intermittent and no heating demand).
Climatic, wind: (bins of wind speed representing low, medium and high infiltration rates).

By default, all elements of this n-dimensional matrix of typologies of day will contain references to CTSM, which will be used to inform heating control actions during the initial training period. Subsequently the matrix will be progressively refined, with elements referencing the CTSM (now trained for this particular building, for the open and sealed cases and predicting which of these applies to each timestep for each zone) or ANN variant that minimises MSE.

In general, the algorithm may work as follows:
Obtain current values of parameters, and add them to the historical data already collected.
Evaluate prediction for the last 24 hours by comparing the last 24-hours predictions for temperature and heating demand with the measured values. Obtain the Mean Squared Error for the last 24 hours. Determine which of CTSM or ANN minimised this error.

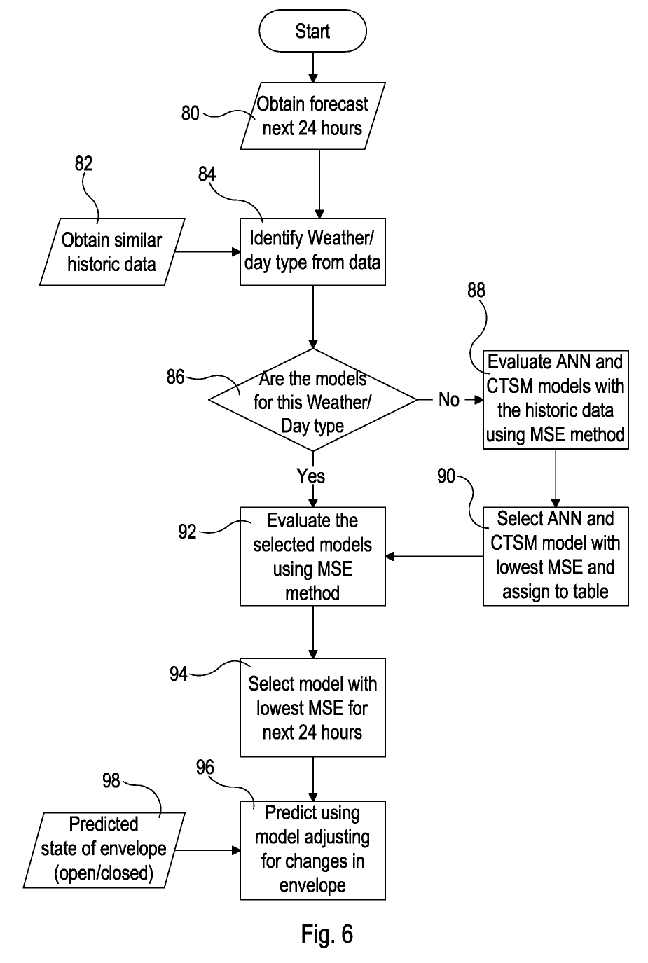

FIG. 6 describes the model selection process in more detail. In step 80 we obtain a forecast for the next 24 hours (in other embodiments a different time period may be chosen). In step 82 we obtain historic data from days with similar weather forecasts. In step 84 we identify the day typology using both the forecast data and the historic data. In step 86 we check whether there is an existing (preferred) model for this type of day. If not, we evaluate ANN and CTSM models with the similar historic data using the MSE method (step 88) and select the ANN and CTSM model with the lowest MSE and assign to a lookup table for the day's typology (step 90). The models in the lookup table for that day type are then selected and evaluated (step 92) and the model with the lowest MSE for the next 24 hours is selected (step 94). The selected model is then used to predict the control requirements for the HEMS for the next 24 hours (step 96) and these predictions are adjusted based on the predicted state of the envelope (open/closed) as per step 98.

Operation/Control of the System

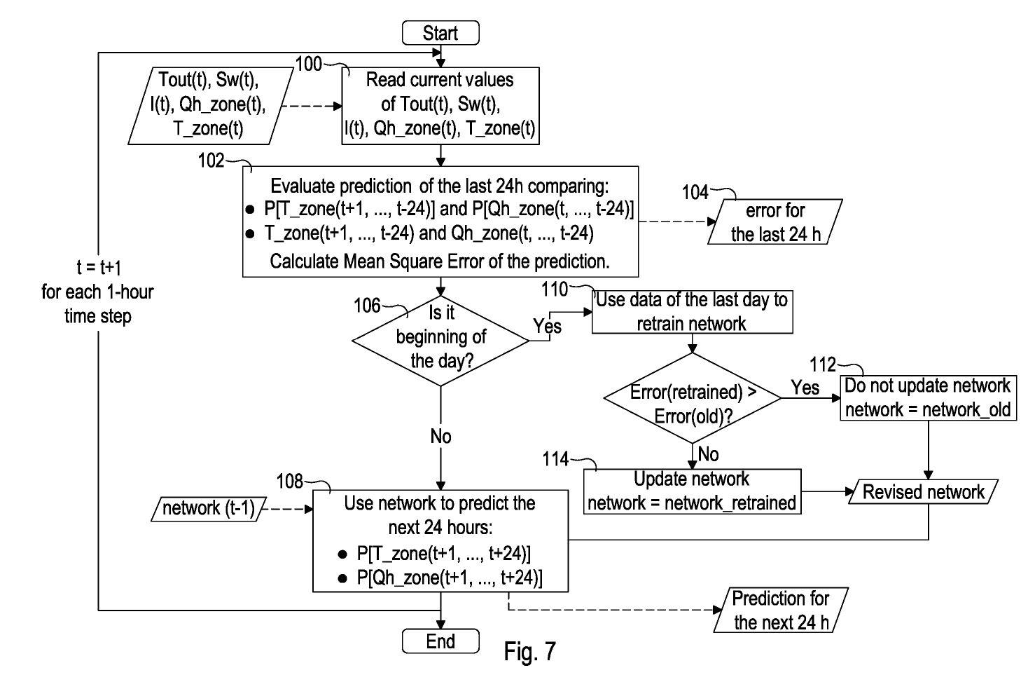

FIG. 7 shows a flow chart illustrating the application of the ANN model of FIGS. 2 and 3 once selected for control purposes, in accordance with an embodiment of the invention. The process is similar to the continuous training process for the ANN as described in FIG. 3 and, again, dashed lines represent data flows and solid lines represent process links.

In the present case, the steps are as follows:

Step 100. At time t, new measured data is recorded, and can be used to evaluate the predictions made at the last time step. The first step is therefore to read the measured values at t for:
Outside temperature: Tout(t)
Wind speed: Sw(t)
Direct solar irradiation: I(t)
Heat flux from heaters in each zone: Qh_zone(t)
Zone temperature in each zone: T_zone(t)

Step 102. The actual measurements of zone conditions at time t and for the last 24 hours up to t−24 (T_zone(t, . . . , t−24) and Qh_zone(t, . . . , t−24)) are then compared with the predicted zone conditions P[T_zone(t, . . . , t−24)] and P[Qh_zone(t, . . . , t−24)], for the same period in order to evaluate the quality of each prediction by calculating the Mean Squared Error, MSE, of the prediction. This produces an error for the last 24 hours (step 104).

Step 106. The system checks whether it is the beginning of the day.

Step 108. If it is not, the ANN is used to predict the zone conditions for the next 24 hours P[T_zone(t, . . . , t+24)] and P[Qh_zone(t, . . . , t+24)] using network(t−1).

Step 110. If it is the beginning of the day, the system uses the data from the last day to retrain the ANN model.

Step 112. If the error for the retrained model is greater than the error for the previous (old) model, the model is not updated and is designated as the revised network.

Step 114. If the error for the retrained model is less than the error for the previous (old) model, the model is updated to the retrained model and is designated as the revised network.

Step 116. The revised network is then used in step 108 to predict the zone conditions for the next 24 hours P[T_zone(t, . . . , t+24)] and P[Qh_zone(t, . . . , t+24)]. The process of FIG. 7 is then repeated for t=t+1 for each 1 hour time step in the 24 hour period.

In some embodiments the BPM may be used in a manner that minimises the risk of dissatisfaction of one or more occupants of the building arising from poor or inaccurate model predictions. This introduces a cautious approach into the control strategy. In these embodiments each of the models is run in the manner described above, but instead of simply selecting the one best model for the control strategy, an approach is used based on the results of the predictions of both (or all) models and a comparison with historical data to determine a level of uncertainty as to how well each of the models is likely to perform.

Accordingly, as in the embodiments described above, each of the models is used to predict, for a chosen time period ahead, one or both of: i) control requirements for the environment management system in light of a current measured system state and a desired future system state or ii) a future system state that would be reached with a particular set of control inputs; wherein the first model comprises a parameterised physical model of the building and the second model comprises an implicit model of the building. As in other embodiments the predictions of the models are evaluated based on prior success at predicting the building's thermal behaviour for conditions similar to conditions that are forecast for the chosen time period ahead. In these embodiments, a range or band of uncertainty is determined for each of the model predictions, to determine what is described hereafter as an uncertainty space.

For example, the uncertainty space may be defined in terms of probabilities. Based on the historical data for use of one model, a statistical distribution of the outcomes of a control strategy can be determined for a parameter, for example the temperature of a room or zone. This can be used as the basis of a probability distribution for the control strategy based on that model's predictions—e.g. probabilities that the temperature deviates from the desired temperature at a certain time by more than a specified number of degrees. This can also be done for different factors that may give rise to the uncertainty—i.e. factors that may contribute to the model getting the prediction wrong, such as uncertainty about the forecast weather. A similar analysis can be carried out for the other model (or models). The uncertainty space therefore represents a distribution of probabilities associated with each of models, based on a statistical analysis of historical data and model predictions.

Based on the determined uncertainty space, a control strategy is selected that minimises a likely level of deviation from the optimum or desired thermal condition of the building. This then allows a “safe” strategy to be selected based on minimising the likelihood of the strategy leading to a condition of the building that is too far away from the desired condition. The selected control strategy includes control parameters for the EMS, which, for example, may be determined from one or other model, or may use another value for the parameter that is at some other value such as a value intermediate those of the predictions of two models. Alternatively, if the uncertainty space indicates that a control parameter provided by both (or all) models is likely to lead to too inaccurate a prediction of the thermal condition whichever model was used, then the strategy may adopt a neutral or conservative value for that control parameter. The EMS is then operated in accordance with the selected strategy to control the environment in the building.

For example, consider a room with a skylight that has been missed from the original setup of the CSTM. Most of the time the CSTM produces a better result than the ANN and therefore tends to have a much higher or even dominant weighting in the control strategy selection. However as the year moves into summer and the sun starts to overheat the room with the skylight, the ANN starts to produce better results. The amount of data that supports the CSTM is much larger than the limited data that supports the ANN (for that room). However we now have a significant divergence in control strategies (based on each of the two models). As more data comes in, the HEMS assigns an increasingly higher probability of overheating to the CSTM. It can therefore take a more and more conservative strategy to heating that room on days that are forecast to be sunny.

At some point, possibly after several years, the HEMS will have enough data to create a separate subset of parameter space, in which the ANN becomes the dominant model and the CSTM is assigned a low probability of forecasting room temperature on forecast sunny days. In reality the HEMS will have more than one, possibly many, different parameters to take account of in this regard, not just the room temperature and the amount of sunshine forecast.

As a counter example, consider a room that has a tree starting to grow, so that it shades a window. Both models correct for solar gain through identifying that forecast sunny days have an impact on heating requirements. The first year that the tree shades the window the CSTM detects that the occlusion parameter in its solar gain model is wrong. The ANN will eventually catch up but requires more training data. During that period the CSTM has a much better track record but the heating input is considered risky (i.e. there are high levels of uncertainty) because of the divergence of the two model predictions. The HEMS therefore adopts the cautious approach of moderating to heat input based on the CSTM predictions.

These examples illustrate a number of features of the system:
1) The inevitability of both inaccuracies (eg wrong dimensions) and errors (missing features) in the CSTM setup;
2) The ability of the ANN to cope with anything that is captured by its input and output parameters;
3) The larger amount of data that the ANN requires to learn than the CSTM;
4) The very large number of potential sets of “circumstances” that the HEMS may have to remember (sunny day in spring, empty house on cold winter day, etc etc);
5) The inevitability of drift (tree growing) and shocks (windows replaced) in the system that require re-evaluation of the model, cause divergence in the predictions from the two models and require relearning and repartitioning of the state sets;
6) There are also other ambiguities—for example the HEMS will recognise, in the first example above, that the CSTM tends to be better on cloudy days and the ANN on sunny ones. It has to select a heating strategy based on the weather forecast. Both weather uncertainty and model uncertainty contribute to its risk strategy. Too much heat on a sunny day and one model says too hot; too little on a cloudy one and the other says too cold. Note that the HEMS may be programmed with data relating to occupant comfort parameters that it would take account of in determining the control strategy to use—i.e. adopting a strategy that will minimise the risk of discomfort to the occupant.

It will be clear from the above that embodiments of the present invention have a number of advantages over the prior art.

It will also be appreciated by persons skilled in the art that various modifications may be made to the above embodiments without departing from the scope of the present invention as defined by the claims. For example, features from one embodiment may be mixed and matched with features from other embodiments.

1. A method of operating an environment management system within a building, comprising:
for each of at least a first and a second model:
A. using the model to predict, for a chosen time period ahead, one or both of: i) control requirements for the environment management system in light of a current measured system state and a desired future system state or ii) a future system state that would be reached with a particular set of control inputs; wherein the first model comprises a parameterised physical model of the building and the second model comprises an implicit model of the building;
B. evaluating the predictions of the first and second models based on prior success at predicting the building's thermal behaviour for conditions similar to conditions that are forecast for the chosen time period ahead;
C. determining a band of uncertainty for the desired or predicted future system state; and
based on the determined uncertainty bands, selecting a control strategy that minimises a likely level of deviation from the desired future system state, the control strategy comprising control parameters for the environment management system, and
operating the environment management system to control the environment in the building in accordance with the selected control strategy.

2. A method of operating an environment management system within a building, comprising:
using a first model to predict, for a chosen time period ahead, one or both of: i) control requirements for the environment management system in light of a current measured system state and a desired future system state or ii) a future system state that would be reached with a particular set of control inputs; wherein the first model comprises a parameterised physical model of the building;
using a second model to predict, for the chosen time period ahead, one or both of: i) control requirements for the environment management system in light of the current measured system state and the desired future system state or ii) a future system state that would be reached with a particular set of control inputs; wherein the second model comprises an implicit model of the building;
evaluating the predictions of the first and second models based on prior success at predicting the building's thermal behaviour for conditions similar to conditions that are forecast for the chosen time period ahead;
selecting one of the first and second models, based on the evaluation; and
operating the environment management system to control the environment in the building in accordance with the selected model for the chosen time period.

3. The method according to claim 2, wherein the predicting of the first and second models includes using weather forecast data for the chosen time period ahead.

4. The method according to claim 2, comprising the construction of plausible hypotheses about the building physics based on inspection by an installation engineer and/or user input.

5. The method according to claim 2, comprising a setup/installation process that attempts to identify major appliances and their location within the building.

6. The method according to claim 5, wherein the setup process comprises inputting data relating to the structure and properties of the building.

7. The method according to claim 2, wherein the first model comprises one or more sub-models selected from a stock of building sub-system models.

8. The method according to claim 7, wherein the sub-models are selected on system installation.

9. The method according to claim 7, wherein the sub-models are selected by an installation engineer or are identified by the system in light of data input by the installation engineer.

10. The method according to claim 7, wherein two or more sub-models may be selected as optional hypotheses, each having a probability weighting.

11. The method according to claim 7, comprising determining a minimum set of sub-models that can provide an effective representation of the building.

12. The method according to claim 2, comprising tuning parameters for the first model until the first model explains the measured system state.

13. The method according to claim 12, comprising modelling dynamics of one or more building systems and its interaction with the physics of the building.

14. The method according to claim 2, comprising a training period to identify appropriate component models and their parameters.

15. The method according to claim 14, wherein the training period is segregated by characteristic parameters.

16. The method according to claim 14, wherein the first model comprises use of Continuous Time Stochastic Models (CTSM).

17. The method according to claim 2, wherein the second model comprises a set of sub-models developed based on segregation by characteristic parameters.

18. The method according to claim 2, wherein the second model comprises an Artificial Neural Network.

19. The method according to claim 2, comprising identifying hidden state variables in the first model and/or sub-models and hypothesising a probable state of said hidden state variables in a predetermined time period.

20. The method according to claim 9, wherein the sub-models offered for selection are chosen or ordered to reflect model structures and/or parameter probability distributions that have been determined to be most successful across multiple environment management systems.

21. The method according to claim 7, wherein the sub-models are configured to receive inputs from other parts of the environment management system.

22. The method according to claim 2, wherein the step of evaluating the predictions of the first and second models comprises comparing model outputs and/or energy inputs.

23. The method according to claim 2, wherein the step of operating the environment management system to control the environment in the building comprises controlling one or more of: a heating system, a hot water system, a ventilation system and a cooling system to achieve the desired future system state.

24. The method according to claim 2, wherein the system is controlled to manage one or more of heat, humidity, condensation and mould.

25. The method according to claim 2, further comprising using parameters from either or both of the first and second models in functions other than direct control of the environment management system.

26. The method according to claim 2, wherein the functions comprise one or more of: budget management, appliance selection, home improvement advice, estimating inherent building efficiencies, providing evidence to support social payments, and targeting sales of products and services.

27. An apparatus for operating an environment management system within a building, comprising:
apparatus for measuring a current system state; and
a processor configured to:
use a first model to predict, for a chosen time period ahead, one or both of: i) control requirements for the environment management system in light of the current measured system state and a desired future system state or ii) a future system state that would be reached with a particular set of control inputs; wherein the first model comprises a parameterised physical model of the building;
use a second model to predict, for the chosen time period ahead, one or both of: i) control requirements for the environment management system in light of the current measured system state and the desired future system state or ii) a future system state that would be reached with a particular set of control inputs; wherein the second model comprises an implicit model of the building;
evaluate the predictions of the first and second models based on prior success at predicting the building's thermal behaviour for conditions similar to conditions that are forecast for the chosen time period ahead;
select one of the first and second models, based on the evaluation; and
operate the environment management system to control the environment in the building in accordance with the selected model for the chosen time period.

28. (canceled)

29. An apparatus according to claim 27 wherein the processor is further configured to, for each of at least a first and a second model determine a band of uncertainty for the desired or predicted future system state; and based on the determined uncertainty bands, select a control strategy that minimises a likely level of deviation from the desired future system state, the control strategy comprising control parameters for the environment management system.

30. (canceled)

31. The method according to claim 2 further comprising determining a band of uncertainty for the desired or predicted future system state; and based on the determined uncertainty bands, selecting a control strategy that minimises a likely level of deviation from the desired future system state, the control strategy comprising control parameters for the environment management system.
